(19) United States
(12) Patent Application Publication
(10) Pub. No.: US 2024/0220312 A1
(43) Pub. Date: Jul. 4, 2024

(54) INTELLIGENT SENSORS FOR HIGH QUALITY SILICON LIFE CYCLE MANAGEMENT AND EFFICIENT INFIELD TESTING

(71) Applicant: Intel Corporation, Santa Clara, CA (US)

(72) Inventors: Rakesh Kandula, Doddakannelli (IN); Shlomo Avni, Ein Hamifratz (IL); Fei Su, Ann Arbor, MI (US)

(73) Assignee: Intel Corporation, Santa Clara, CA (US)

(21) Appl. No.: 18/091,810

(22) Filed: Dec. 30, 2022

(51) Int. Cl. G06F 9/48; G06F 11/263

(52) U.S. Cl. CPC G06F 9/4812; G06F 11/263

(57) ABSTRACT

Methods and apparatus relating to intelligent sensors for high quality silicon life cycle management as well as efficient infield structural and/or functional testing are described. In an embodiment, one or more registers store configuration data. A sensor having sensor event detection logic circuitry detects an event based at least in part on one or more sensor signals and the stored configuration data. The sensor event detection logic circuitry generates a signal to cause interrupt generator logic circuitry of the sensor to generate an interrupt. Other embodiments are also disclosed and claimed.

### FIELD

The present disclosure generally relates to the field of electronic sensors. More particularly, some embodiments relate to intelligent sensors for high quality silicon life cycle management as well as efficient infield testing.

### BACKGROUND

Modern electronic devices tend to include at least one integrated circuit device. These integrated circuit devices may take on a variety of forms, including processors (e.g., Central Processing Units (CPUs)), memory devices, and programmable devices (such as Field Programmable Gate Arrays (FPGAs), to name only a few examples.

To improve reliability and/or performance, some integrated circuit devices may be monitored during their life cycle. For example, this monitoring may allow for the determination of whether an integrated circuit device is functioning as intended. Hence, device monitoring can improve reliability and/or performance of integrated circuit devices.

### BRIEF DESCRIPTION OF THE DRAWINGS

The detailed description is provided with reference to the accompanying figures. In the figures, the left-most digit(s) of a reference number identifies the figure in which the reference number first appears. The use of the same reference numbers in different figures indicates similar or identical items.

FIG. 1 illustrates sample components of a system with an intelligent sensor, according to an embodiment.

FIG. 2 illustrates a sample format for an interrupt message sent by an intelligent sensor for a system which may be utilized in one or more embodiments.

FIG. 3 illustrates a flow diagram of a method to operate an intelligent sensor, according to an embodiment.

FIGS. 4A, 4B, and 4C illustrate sample vector pattern detection examples, according to some embodiments.

FIG. 4D illustrates a sample graph pattern detection example, according to an embodiment.

FIG. 4E illustrates a sample graph pattern detection example, according to an embodiment.

FIG. 4F illustrates a sample time window detection example, according to an embodiment.

FIG. 5 illustrates one or more components of a system for an efficient infield parametric management which leverages intelligent sensor(s), according to an embodiment.

FIG. 6 illustrates a flow diagram of a method for selection of high-quality parametric stress tests using intelligent sensors, according to an embodiment.

FIG. 7 illustrates one or more components of a system for conversion of pre-silicon test content, according to an embodiment.

FIG. 8 illustrates an example computing system.

FIG. 9 illustrates a block diagram of an example processor and/or System on a Chip (SoC) that may have one or more cores and an integrated memory controller.

### DETAILED DESCRIPTION

In the following description, numerous specific details are set forth in order to provide a thorough understanding of various embodiments. However, various embodiments may be practiced without the specific details. In other instances, well-known methods, procedures, components, and circuits have not been described in detail so as not to obscure the particular embodiments. Further, various aspects of embodiments may be performed using various means, such as integrated semiconductor circuits (“hardware”), computer-readable instructions organized into one or more programs (“software”), or some combination of hardware and software. For the purposes of this disclosure reference to “logic” shall mean either hardware (such as logic circuitry or more generally circuitry or circuit), software, firmware, or some combination thereof.

As mentioned above, device monitoring can improve reliability and/or performance of integrated circuit devices. Generally, silicon life cycle management of integrated circuit devices requires several parameters to be monitored at the silicon or platform level. Some of the critical parameters that are monitored may include: voltage (e.g., by voltage level and droop monitors), thermal (e.g., by a Thermal Variation Monitor (TVM)), process variation (e.g., by in-die variation monitors), clock (e.g., by duty cycle and skew Monitors), Performance monitor (PerfMon) Counters, CPU power modes/states (e.g., C-State) residency counters, and/or other telemetry information. This type of information needs to be read out for manufacturing tests as well as for functional infield and lifecycle management purposes. During manufacturing tests, the majority of the readings are performed using a Joint Test Action Group (JTAG) Test Access Port (TAP) controller (e.g., in compliance with the Institute of Electrical and Electronics Engineers (IEEE) 1149.1/1149.7 or IEEE 1687 TAP controllers). However, for infield and for silicon life cycle management, this raw data still needs to be continuously monitored and processed. The processing is generally done using firmware or software and the output is to be consumed by the CPU after post-processing. Additionally, this data may be sent to the cloud during the regular mission-mode of the silicon/platform for infield and silicon life cycle management purposes.

To this end, some embodiments provide one or more intelligent sensors for high quality silicon life cycle management as well as efficient infield structural and/or functional testing. More particularly, at least one embodiment provides an intelligent sensor (e.g., a sensor having access to logic circuitry) to allow the sensor to send a notification to the another entity (e.g., firmware/software) in response to detection of data of interest (e.g., where the data of interest is indicative of occurrence of an event). This approach, in turn, would allow for selective probing of a sensor (by firmware or software) and without the need to probe all sensors in the system (e.g., across an SoC). Also, this approach not only improves the quality of data provided by a sensor but also reduces the required periodic monitoring time considerably by effectively avoiding a permanent failure in the SoC.

Generally, for silicon life cycle management, it is essential that firmware/software send sensor data for continuously monitoring the silicon health. For firmware/software to do so, the firmware/software would need to periodically monitor all the sensors across a System on Chip (“SoC” or “SOC”) in some implementations, independent of whether the sensors have the data of interest or not. This causes the firmware/software to unnecessarily probe the sensors even when there is no data of interest. This aggravates the firmware/software monitoring time and the unneeded non-anomaly data (where, in this context, an anomaly is defined as a deviation from an expected behavior) limit the overall number of sensors data that can be supported due to physical limitation, in turn, causing greater inefficiencies to the overall silicon life cycle management process.

Further, some existing implementations have to monitor all the sensors to enable continuously monitoring/telemetry. This leads to much larger probing time during the periodic testing. Moreover, this also leads to a high volume of telemetry data intervening with the real-time system functional traffic. This could reduce effective bandwidth (BW) of the functional traffic. Also, during infield scan testing, the toggling rate is much higher compared to the toggling rate during real-time functioning of an SoC. Because of this, the various critical parameters such as power consumption, temperature, voltage droop, etc. of the SoC can spike abnormally during the scan capture. The infield scan test controller probes all temperature sensors to effectively manage these critical parameters that can lead to permanent failure of SoC functionality. Probing all such critical sensors could also result in a high probing time or monitoring which is highly restricted during infield testing.

In contrast to some embodiments, one or more disadvantages of current implementations may include that: (1) the volume of the data of no interest is very high compared to the volume of useful data (e.g., anomaly) collected using intelligent sensors; (2) because firmware/software monitor all the sensors, the required probing time would be high considering the strict requirements of the periodic monitoring time; (3) the number of telemetry end points to be monitor in system are severely limited because of throughputs and bandwidth restriction of the connected fabrics between the sensors and the firmware; (4) the existing sensors do not have the intelligence of sending an interrupt when an event of interest is detected, which would result in the firmware waiting for its turn to read the sensor data during the periodic monitoring time (e.g., resulting in firmware reading the sensor data after permanent failure has occurred in SoC); and/or (5) the existing sensors do not have the feature extraction capability, where the feature extraction capability is defined as the capability of extracting various feature of the data of interest (e.g., when abnormal spike or droop is detected, the sensors are able to extract the various abnormality features).

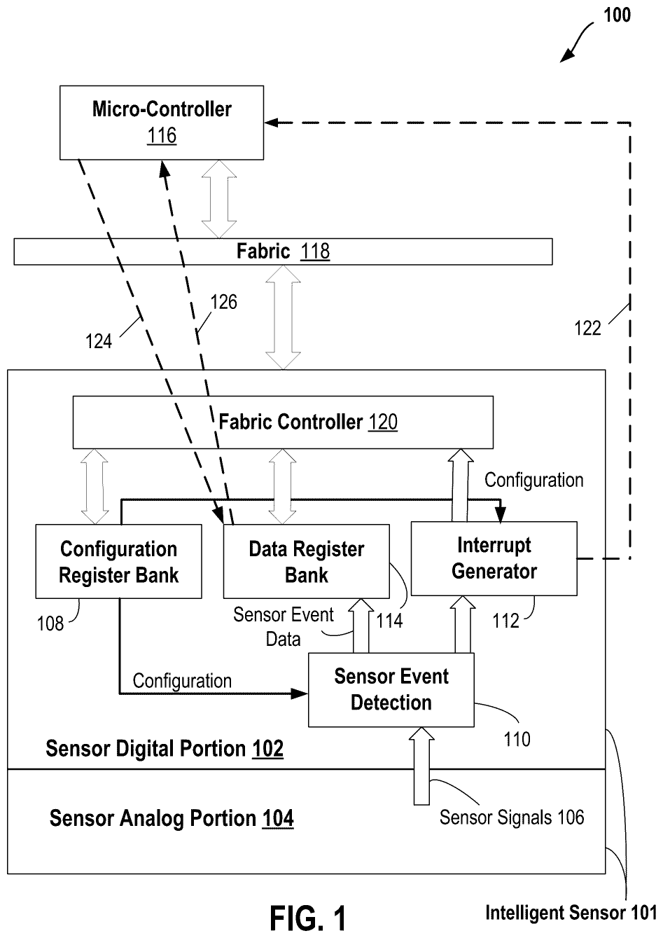

FIG. 1 illustrates sample components of a system 100 with an intelligent sensor, according to an embodiment. System 100 includes an intelligent sensor 101 having a digital portion 102 and an analog portion 104. The sensor analog portion 104 may physically couple with a device under test or target/monitored device to detect physical characteristics such as temperature, voltage, electric current, power consumption, clock signal, process variations, aging, timing, etc. The sensor analog portion 104 may then generate sensor signal(s) 106 based on the detected physical characteristics and communicate them to the sensor digital portion 102. While the intelligent sensor discussed with reference to FIG. 1 includes analog and digital portions, embodiments are not limited to a two-part intelligent sensor and an intelligent sensor may only include a digital portion to detect one or more physical characteristics.

Referring to FIG. 1, a configuration register bank 108 incorporates the registers that store values that are used to configure the setting of intelligent sensor 101, e.g., including feature extraction mentioned below. In at least one embodiment, one or more registers mentioned herein (e.g., within a register bank or otherwise) are read and/or write protected. Alternatively, all registers used herein to store configuration and/or sensor data may be read and/or write protected. The register protection can provide security otherwise not available in some current implementations (e.g., based on JTAG access). The examples of configuration may include the setting of select threshold values to trigger an interrupt/event generation that is described herein. A sensor event detection logic 110 receives the sensor data (e.g., via sensor signals 106) along with the configuration register values from register bank 108. In turn, the sensor event generator logic 110 incorporates the various conditions with respect to certain criteria set by configuration registers. For example, if there is any abnormality detected with respect to the threshold value ranges programmed in the registers of the register bank 108, the event detection logic 110 generates and sends a signal to an interrupt generator logic 112.

A data register bank 114 stores the sensor event data generated by sensor event detection logic 110, which can be further accessed a micro-controller 116 coupled to the intelligent sensor 101. The interrupt/event generator logic 112 forms the packet for an interrupt/event message based on the system bus/fabric 118 that is coupled to the intelligent sensor 101. As shown in FIG. 1, configuration information for the interrupt generator logic 112 may be stored in the configuration register bank 108.

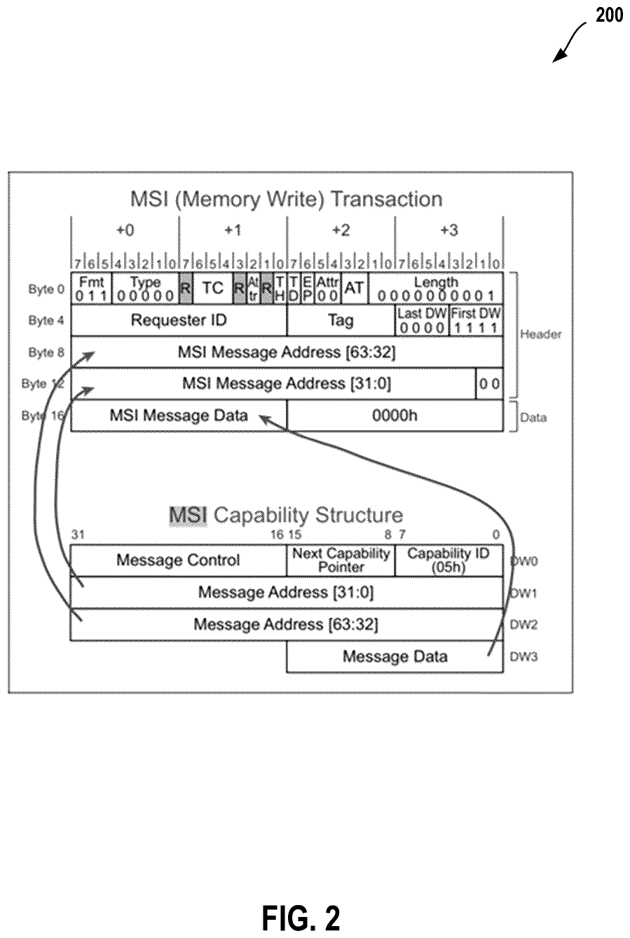

Furthermore, in one example, if the intelligent sensor 101 is attached to a Peripheral Component Interconnect express (PCIe) system bus 118, then an interrupt controller logic 120 sends the message in a standard PCIe Message Signaled interrupt (MSI) format as shown in FIG. 2. More particularly, FIG. 2 illustrates a sample format 200 for an interrupt message sent by an intelligent sensor for a fabric based system which may be utilized in one or more embodiments. While FIG. 2 shows a sample MSI format, embodiments are not limited to this format and other message formats may be used.

Referring back to FIG. 1, a fabric controller 120 handles the bus protocol to which the sensor is attached. In some examples, the intelligent sensor 101 is coupled to an On-Chip System Fabric (OSF) (such as an Intel® On-Chip System Fabric (IOSF)), and then the fabric controller 120 may also provide a credit mechanism, request/put handshakes, Idle State Machine (ISM) transitions, etc. Hence, embodiments are not limited to just one type of fabric (such as OSF, IOSF, PCIe, Advanced extensible Interface (AXI), Advanced Peripheral Bus (APB), etc.) and any type of shared bus/interconnect or point-to-point interconnect/connection may be used for fabric 118, e.g., to allow communication between the intelligent sensor 101 and the micro-controller 116. Also, the micro-controller 116 may include any logic capable of processing interrupt messages such as a power management controller, a processor/processor core, FPGA, CPU, etc. Furthermore, the MSI format of FIG. 2 may be utilized in PCIe and/or OSF/IOSF implementations in various embodiments.

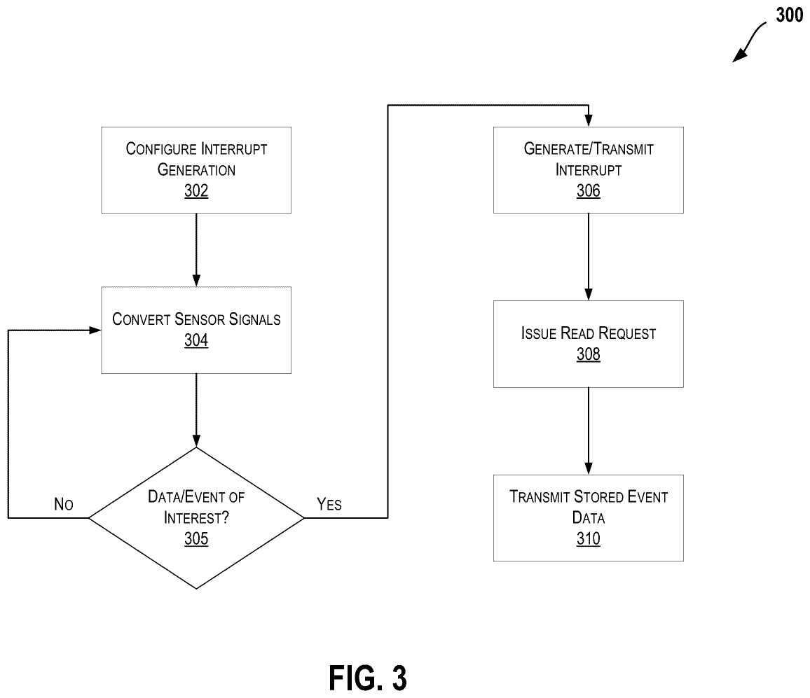

FIG. 3 illustrates a flow diagram of a method 300 to operate an intelligent sensor, according to an embodiment. One or more of the operations of method 300 may be performed by one or more components of the system 100 of FIG. 1 to operate the intelligent sensor 101.

Referring to FIGS. 1 and 3, at an operation 302, the values stored in the configuration registers of the configuration register bank 108 are used to set/configure the interrupt/event generation criteria (in the sensor even detection logic 110) for a target sensor. At an operation 304, the (e.g., raw) sensor signals 106 are converted into the event of interest by sensor event detection logic 110.

At an operation 305, upon detection of an event or data of interest (e.g., based on the configuration register values stored in the configuration register bank 108), the interrupt generator logic 112 generates and transmits an interrupt to the micro-controller 116 through the fabric 118 (transaction 122 in FIG. 1) at an operation 306. At an operation 308, the micro-controller 116 issues/transmits a read request signal to the intelligent sensor that has issued the interrupt of operation 306 (transaction 124 in FIG. 1). At an operation 310, the sensor sends back the event data (e.g., stored in the data register bank 114) to the micro-controller 116 (transaction 126 in FIG. 1). This transaction may contain the values from the sensor that are extracted by the event detection logic 110 as discussed with reference to in FIG. 1.

### Sensor Event Detection

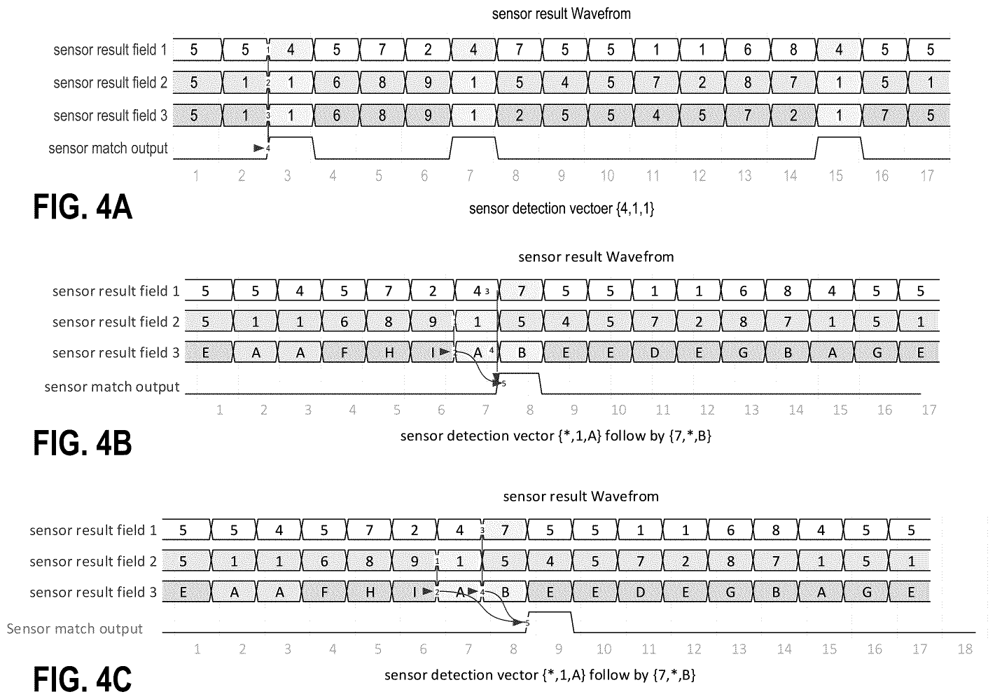

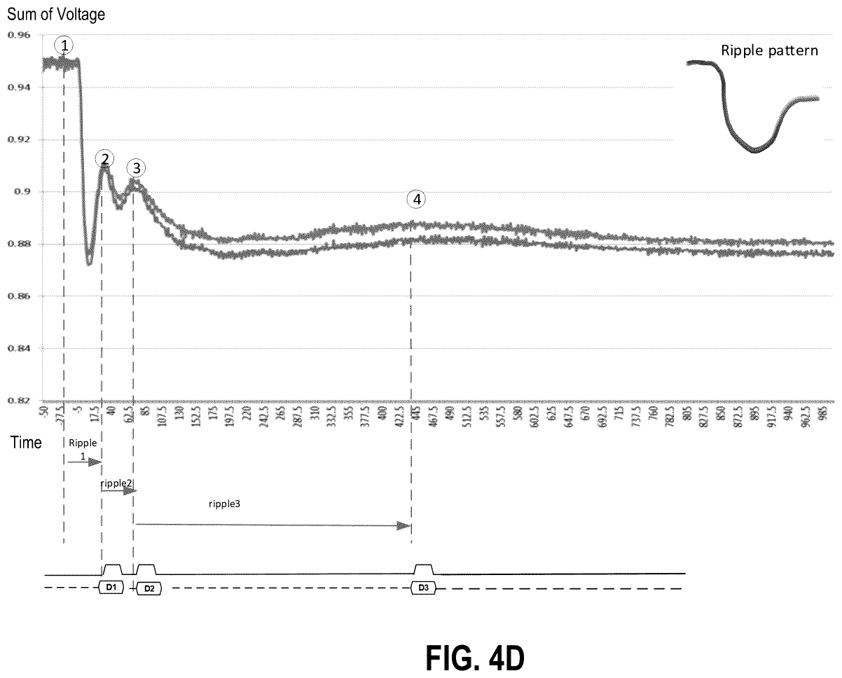

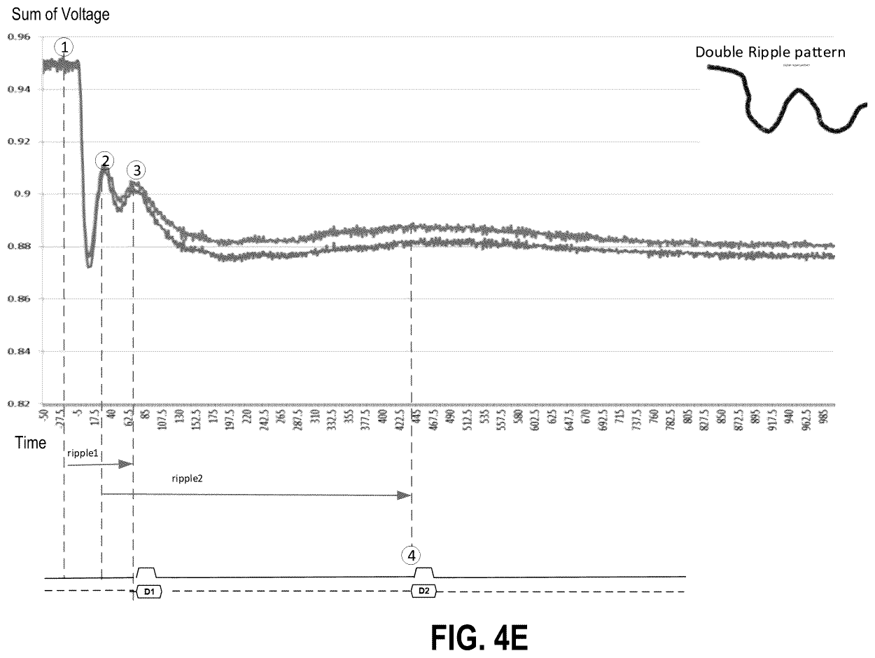

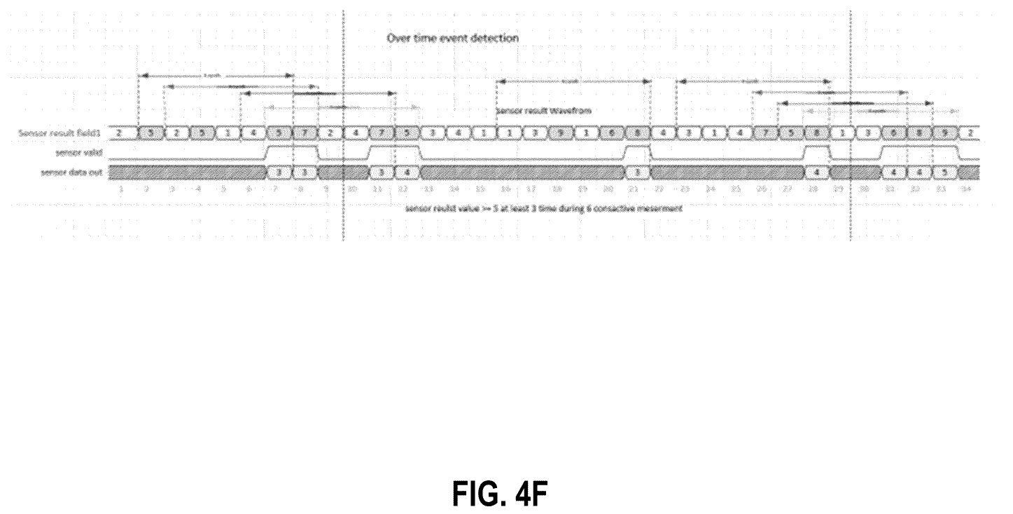

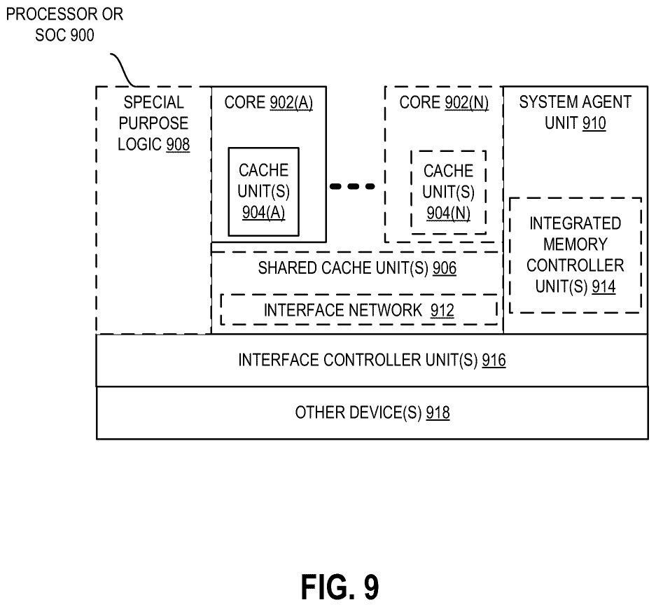

Generally, the sensors used in an SoC (such as the SoC of FIG. 9) may cover many different telemetry parameters, e.g., including voltage, temperature, aging, timing, clocks, electric current, etc. Each sensor may have different work/functional modes including, for example, analog to digital conversion functionality, Delay Locked Loop (DLL) functionality (e.g., with a programmable delay), an attribute conversion to frequency function, signal filtering, signal amplificon, and other processing functions, etc. In an embodiment, the proposed intelligent sensors may use a programmable event recognition, for example, because such sensor output may have different structures (such as a different number of fields based on the mode). There are several different types of event recognition such as those listed below (however, embodiments are not limited to the just the listed event recognitions mentioned and other event recognitions may be used):
(a) Singular Event—this event occurrence is based on a single parameter/field of the sensor value. Some of the examples of such parameters include: maximum value, minimum value, threshold value, result value change with respect to a pre-determined number, result value change with respect to a pre-defined percentage, etc.
(b) Pattern Recognition—this event occurrence is based on vector pattern match detection (see, e.g., FIGS. 4A, 4B, and 4C).
(c) Graph Pattern Detection—this even occurrence is based on graph pattern match detection (see, e.g., FIGS. 4D and 4E).
(d) Over Time Event—this event occurrence is based on the number of singular events or patterns occurring in a defined time window (see e.g., FIG. 4F).

FIGS. 4A, 4B, and 4C illustrate sample vector pattern detection examples, according to some embodiments. More particularly, FIG. 4A shows an example of a sample sensor result waveform with sensor detection vector {4,1,1}. As can be seen, each time sensor result fields 1-3 match the vector {4,1,1}, the sensor match output signal is asserted. In this example, a sensor issues three measurement traces (labeled as sensor result fields 1-3). The sensor is programmed to detect a known value which is vector {4,1,1} in this example, and when sensor detects such a pattern it sends the match indication.

FIG. 4B shows an example for a partial vector pattern detection, according to an embodiment. In this example, the sensor is programmed to detect a known value using 2 out of 3 measurements, e.g., {*, 1, 1} issued at the same time on 3 measurement fields (* means don't care). When sensor detects such a pattern, it sends match indication.

FIG. 4C shows an example for vector pattern detection continuously over time, according to an embodiment. In the example of the FIG. 4C, the sensor is programmed to detect a predefined pattern over time, e.g., measurement {*,1, A} followed by {7,*,B}. When the sensor detects such a pattern over-time, it sends a match indication.

FIG. 4D illustrates a sample graph pattern detection example, according to an embodiment. In this example, an intelligent sensor may include a voltage sensor to detect a single ripple pattern as shown. For example, an intelligent voltage sensor may be programmed to detect a single ripple pattern. When the sensor detects the occurrence of a single ripple (considering detection points marked as 1-4), the sensor sends an indication and the associated data out.

FIG. 4E illustrates a sample graph pattern detection example, according to an embodiment. In this example, an intelligent sensor may include a voltage sensor to detect multiple ripple patterns as shown. For example, an intelligent voltage sensor is programmed to detect a double-ripple pattern. When sensor detects the occurrence of a double-ripple pattern, it sends an indication and the associated data out.

FIG. 4F illustrates a sample time window detection example, according to an embodiment. In this example, the sensor detects the number of events exceeding a threshold in a window of time. For example, an intelligent voltage sensor is programmed to detect that number of events exceeding a programmable threshold during a preamble window time. In this example, during the first window time (e.g., set to six event cycles in FIG. 4F), there are three events that exceed the threshold (set to four here), and the sensor sends the data “3” out at the end of this window time.

### Infield Parametric Management by Leveraging Intelligent Sensors

Infield test refers to an SoC product feature required by data center/server customers (which may also be called a “Scan at field”). An SoC may include the infield test feature to meet functional safety standard for automotive applications (such as Automotive Safety Integrity Level (ASIL)) and/or industrial applications (such as Safety Integrity Level (SIL)). In more highly safety critical systems like automotive SoCs, infield test may run once every Fault Tolerant Time Interval (FTTI) which is of the order of 100 to 150 ms in some implementations.

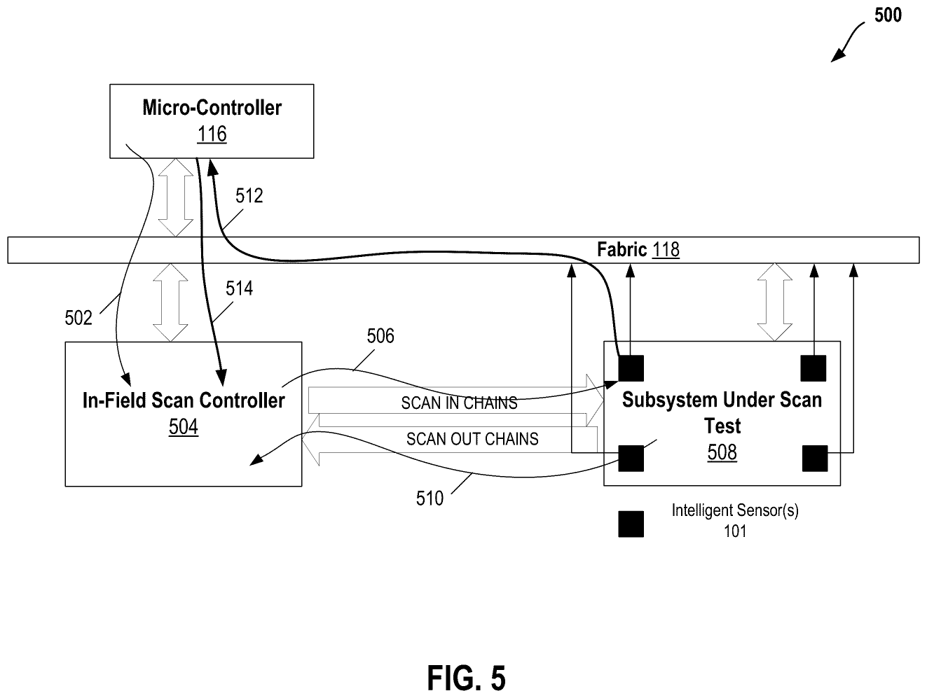

As the Infield scan tests are executed, the toggling rate is very high compared to the toggling an SoC undergoes during real-time functional execution. This is because a scan would toggle almost all the sequential elements and may also toggle the combinational gates during the scan capture phase. The power consumption is significantly higher during the scan operation, in part, because scan is a massively parallel operation. This is true not only with power consumption but can also be true with other SoC critical parameters such as voltage, temperature, etc. With the intelligent sensors embedded in SoC such as discussed with reference to some embodiments, the infield testing can be effectively managed as shown in FIG. 5.

More particularly, FIG. 5 illustrates one or more components of a system 500 for an efficient infield parametric management which leverages intelligent sensor(s), according to an embodiment.

Referring to FIG. 5, at a transaction 502, an infield test start bit is programmed inside the infield scan controller 504 by the micro-controller 116. At a transaction 506, during a scan capture phase, the subsystem under scan test 508 undergoes high toggling rate. Because of this, one of the critical parameters can spike up to a critical or an abnormal value.

At a transaction 510, one of the corresponding intelligent sensor(s) 101 senses an abnormal parametric variation. At a transaction 512, the corresponding intelligent sensor sends an interrupt to the micro-controller 116. At a transaction 514, the micro-controller 116 reprograms the infield scan controller 504 to reduce the clock frequency and/or to reduce the testing for number of scan chains.

Utilizing the intelligent sensor(s) 101, the firmware/software that is running on the micro-controller 116 need to probe only the sensors that have detected an anomaly. For example, if there are ten sensors in a Universal Serial Bus (USB) controller and one sensor has detected an anomaly and has sent an interrupt to the firmware/software, the firmware/software now only monitors one sensor against all the then sensors. That results in probing time reduction of 90%.

### Quality Selection of Parametric Stress Based Functional Tests for Both High Volume Manufacturing (HVM) and In-Field Testing Using Intelligent Sensors

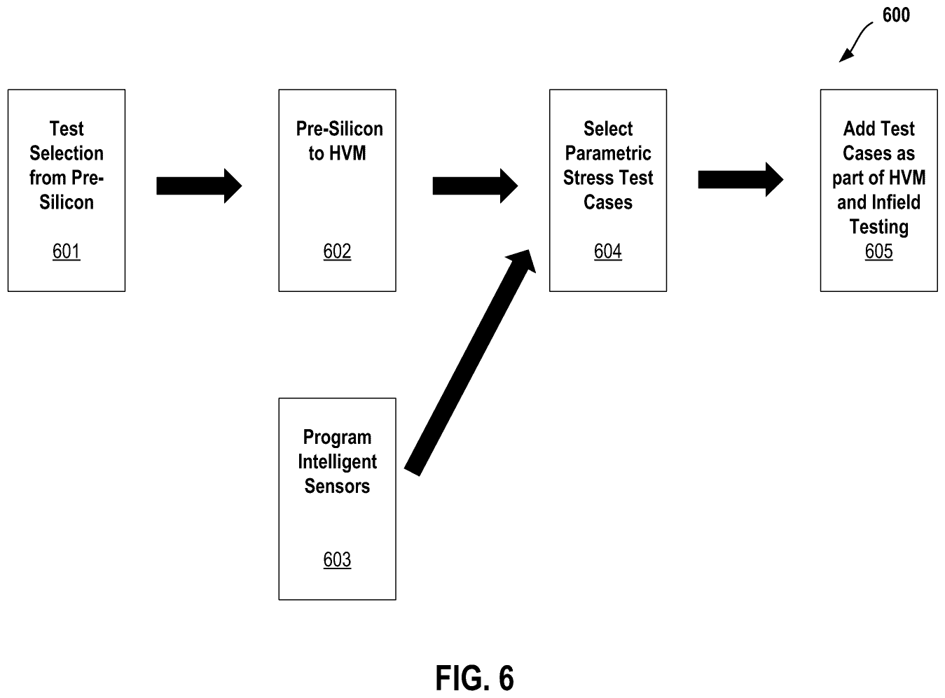

FIG. 6 illustrates a flow diagram of a method 600 for selection of high-quality parametric stress tests using intelligent sensors, according to an embodiment.

Parametric functional tests generally refer to the tests that stress the parameters such as voltage droop, temperature, performance, etc. Some functional tests (e.g., because of their nature of the traffic induced into SoC or into subsystem of interest) may test the up to the extreme legal value of a particular parameter. For example, a loop back test in PCIe controller with complete filling in retry buffer can increase the back-to-back traffic on the link, which may stress the voltage level of the link. These tests are selected for silicon life cycle management to monitor the health. FIG. 6 shows some operations that may be followed using the intelligent sensors to select high quality parametric functional tests in accordance with some embodiments.

At operation 601, for a particular subsystem the tests can be selected from pre-silicon functional test plan based on end-to-end functional use case of a particular feature and based on the high code coverage (e.g., line and toggle). As an example, for a given subsystem, there may be N features, and N pre-silicon test cases are selected satisfying above mentioned criteria.

Operation 602 converts the selected functional test cases to HVM based test case. For example, USB subsystem attaches to IOSF bus in some SoCs. At operation 601, a test case is selected that accesses the USB feature through IOSF bus. In the HVM world, access may only be provided through HVM interfaces such as JTAG, Structural Test Fabric (STF), or Streaming Scan Network (SSN), etc. In this example, the IOSF based traffic of USB subsystem is converted to HVM based packets. These HVM based packets are then converted to IOSF traffic using functional testing agents such as JTAG to IOSF, SSN2IOSF, etc.

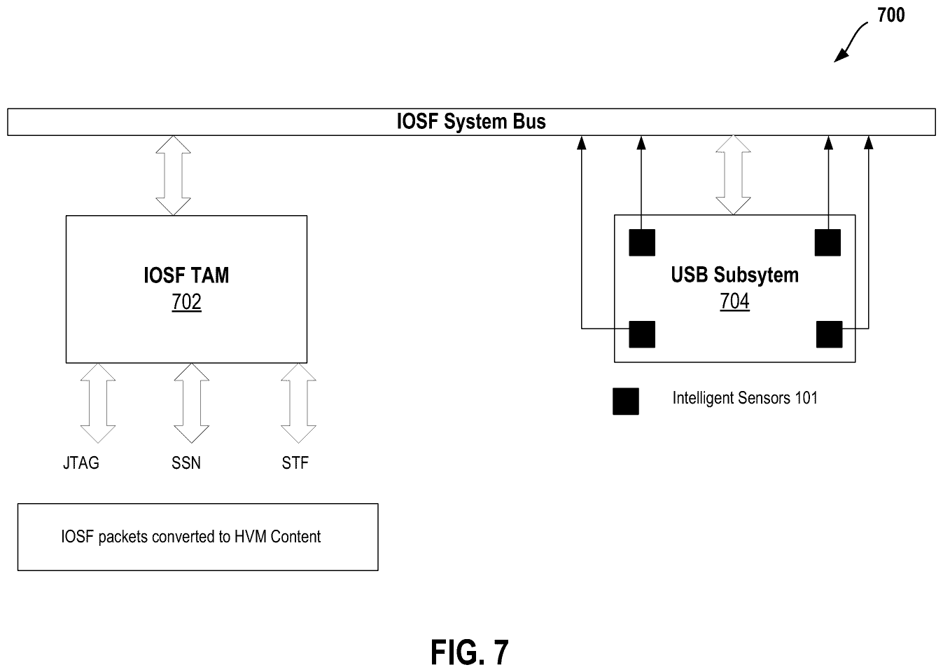

More particularly, FIG. 7 illustrates one or more components of a system 700 for conversion of pre-silicon test to HVM content, according to an embodiment. The HVM content may then be passed it through IOSF Test Access Mechanism (TAM) 702 to test USB 704 in an HVM environment.

Referring to FIGS. 6 and 7, at operation 603, the threshold registers inside intelligent sensors are programmed such that they match the peak value of sensors inside the subsystem under test. For example, if USB subsystem functional operating voltage range is between the range of approximately 1.1V to 1.7V, then the threshold register inside intelligent sensor is set to approximately 1.69V. At operation 604, the selected HVM functional tests from operations 601 and 602 are executed. Test cases in which the intelligent sensor has sent an interrupt are filtered. These tests stress the critical parameters (be it voltage, temperature, etc.). At operation 605, these tests are added as part of HVM tests main suite and as part of Infield tests.

Accordingly, large scale telemetry (such as where millions of processors generate detailed snapshots and reports frequently in time) and growing more types and instantiations of real-time sensors (such as when a single processor is streaming continuous state information to a local aggregator or controller) face the challenge of consuming the sheer volume of data. This volume of data can be qualitatively and quantitatively selected based on one or more embodiments that utilize intelligent sensor(s). In addition, with such intelligent sensors, the probing time by firmware/software of sensors' data may be reduced drastically (e.g., anywhere from approximately 50% to over 90% in some implementations). With the saved probing time, more quality anomaly data may be leveraged. This in turn may be used to provide effective silicon life cycle management as well as infield scan testing.

Additionally, some embodiments may be applied in computing systems that include one or more processors (e.g., where the one or more processors may include one or more processor cores), such as those discussed with reference to FIG. 1 et seq., including for example a desktop computer, a workstation, a computer server, a server blade, or a mobile computing device. The mobile computing device may include a smartphone, tablet, UMPC (Ultra-Mobile Personal Computer), laptop computer, Ultrabook™ computing device, wearable devices (such as a smart watch, smart ring, smart bracelet, or smart glasses), etc.

### Example Computer Architectures

Detailed below are descriptions of example computer architectures. Other system designs and configurations known in the arts for laptop, desktop, and handheld personal computers (PC)s, personal digital assistants, engineering workstations, servers, disaggregated servers, network devices, network hubs, switches, routers, embedded processors, digital signal processors (DSPs), graphics devices, video game devices, set-top boxes, micro controllers, cell phones, portable media players, hand-held devices, and various other electronic devices, are also suitable. In general, a variety of systems or electronic devices capable of incorporating a processor and/or other execution logic as disclosed herein are generally suitable.

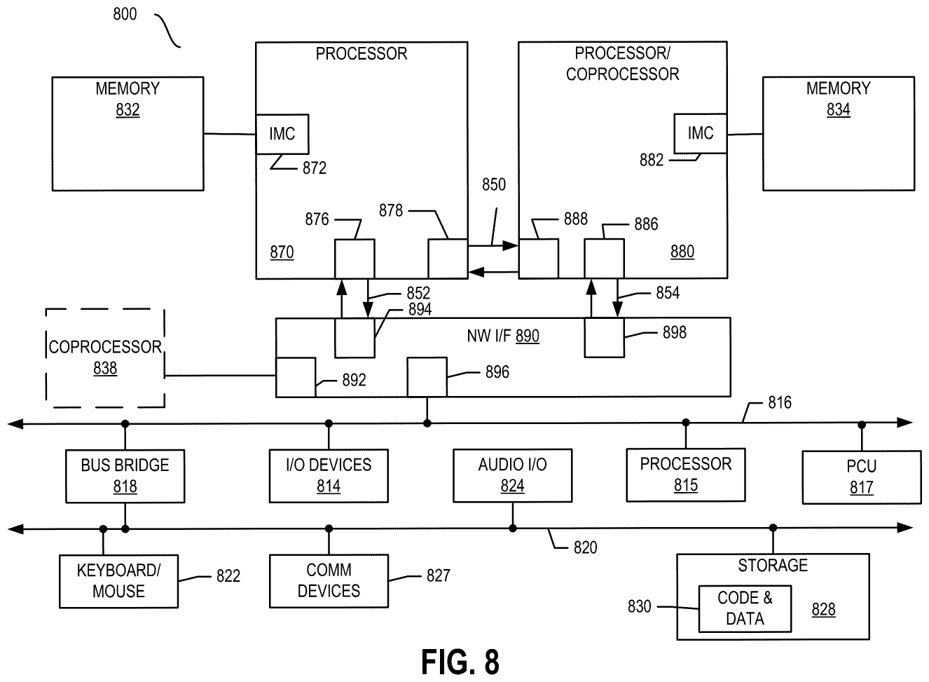

FIG. 8 illustrates an example computing system. Multiprocessor system 800 is an interfaced system and includes a plurality of processors or cores including a first processor 870 and a second processor 880 coupled via an interface 850 such as a point-to-point (P-P) interconnect, a fabric, and/or bus. In some examples, the first processor 870 and the second processor 880 are homogeneous. In some examples, first processor 870 and the second processor 880 are heterogenous. Though the example system 800 is shown to have two processors, the system may have three or more processors, or may be a single processor system. In some examples, the computing system is a system on a chip (SoC).

Processors 870 and 880 are shown including integrated memory controller (IMC) circuitry 872 and 882, respectively. Processor 870 also includes interface circuits 876 and 878; similarly, second processor 880 includes interface circuits 886 and 888. Processors 870, 880 may exchange information via the interface 850 using interface circuits 878, 888. IMCs 872 and 882 couple the processors 870, 880 to respective memories, namely a memory 832 and a memory 834, which may be portions of main memory locally attached to the respective processors.

Processors 870, 880 may each exchange information with a network interface (NW I/F) 890 via individual interfaces 852, 854 using interface circuits 876, 894, 886, 898. The network interface 890 (e.g., one or more of an interconnect, bus, and/or fabric, and in some examples is a chipset) may optionally exchange information with a coprocessor 838 via an interface circuit 892. In some examples, the coprocessor 838 is a special-purpose processor, such as, for example, a high-throughput processor, a network or communication processor, compression engine, graphics processor, general purpose graphics processing unit (GPGPU), neural-network processing unit (NPU), embedded processor, or the like.

A shared cache (not shown) may be included in either processor 870, 880 or outside of both processors, yet connected with the processors via an interface such as P-P interconnect, such that either or both processors' local cache information may be stored in the shared cache if a processor is placed into a low power mode.

Network interface 890 may be coupled to a first interface 816 via interface circuit 896. In some examples, first interface 816 may be an interface such as a Peripheral Component Interconnect (PCI) interconnect, a PCI Express interconnect or another I/O interconnect. In some examples, first interface 816 is coupled to a power control unit (PCU) 8 17, which may include circuitry, software, and/or firmware to perform power management operations with regard to the processors 870, 880 and/or co-processor 838. PCU 817 provides control information to a voltage regulator (not shown) to cause the voltage regulator to generate the appropriate regulated voltage. PCU 817 also provides control information to control the operating voltage generated. In various examples, PCU 817 may include a variety of power management logic units (circuitry) to perform hardware-based power management. Such power management may be wholly processor controlled (e.g., by various processor hardware, and which may be triggered by workload and/or power, thermal or other processor constraints) and/or the power management may be performed responsive to external sources (such as a platform or power management source or system software).

PCU 817 is illustrated as being present as logic separate from the processor 870 and/or processor 880. In other cases, PCU 817 may execute on a given one or more of cores (not shown) of processor 870 or 880. In some cases, PCU 817 may be implemented as a microcontroller (dedicated or general-purpose) or other control logic configured to execute its own dedicated power management code, sometimes referred to as P-code. In yet other examples, power management operations to be performed by PCU 817 may be implemented externally to a processor, such as by way of a separate power management integrated circuit (PMIC) or another component external to the processor. In yet other examples, power management operations to be performed by PCU 817 may be implemented within BIOS or other system software.

Various I/O devices 814 may be coupled to first interface 816, along with a bus bridge 818 which couples first interface 816 to a second interface 820. In some examples, one or more additional processor(s) 815, such as coprocessors, high throughput many integrated core (MIC) processors, GPGPUs, accelerators (such as graphics accelerators or digital signal processing (DSP) units), field programmable gate arrays (FPGAs), or any other processor, are coupled to first interface 816. In some examples, second interface 820 may be a low pin count (LPC) interface. Various devices may be coupled to second interface 820 including, for example, a keyboard and/or mouse 822, communication devices 827 and storage circuitry 828. Storage circuitry 828 may be one or more non-transitory machine-readable storage media as described below, such as a disk drive or other mass storage device which may include instructions/code and data 830 and may implement the storage for one or more instructions in some examples. Further, an audio I/O 824 may be coupled to second interface 820. Note that other architectures than the point-to-point architecture described above are possible. For example, instead of the point-to-point architecture, a system such as multiprocessor system 800 may implement a multi-drop interface or other such architecture.

### Example Core Architectures, Processors, and Computer Architectures.

Processor cores may be implemented in different ways, for different purposes, and in different processors. For instance, implementations of such cores may include: 1) a general purpose in-order core intended for general-purpose computing; 2) a high-performance general purpose out-of-order core intended for general-purpose computing; 3) a special purpose core intended primarily for graphics and/or scientific (throughput) computing. Implementations of different processors may include: 1) a CPU including one or more general purpose in-order cores intended for general-purpose computing and/or one or more general purpose out-of-order cores intended for general-purpose computing; and 2) a coprocessor including one or more special purpose cores intended primarily for graphics and/or scientific (throughput) computing. Such different processors lead to different computer system architectures, which may include: 1) the coprocessor on a separate chip from the CPU; 2) the coprocessor on a separate die in the same package as a CPU; 3) the coprocessor on the same die as a CPU (in which case, such a coprocessor is sometimes referred to as special purpose logic, such as integrated graphics and/or scientific (throughput) logic, or as special purpose cores); and 4) a system on a chip (SoC) that may be included on the same die as the described CPU (sometimes referred to as the application core(s) or application processor(s)), the above described coprocessor, and additional functionality. Example core architectures are described next, followed by descriptions of example processors and computer architectures.

FIG. 9 illustrates a block diagram of an example processor and/or SoC 900 that may have one or more cores and an integrated memory controller. The solid lined boxes illustrate a processor 900 with a single core 902(A), system agent unit circuitry 910, and a set of one or more interface controller unit(s) circuitry 916, while the optional addition of the dashed lined boxes illustrates an alternative processor 900 with multiple cores 902(A)-(N), a set of one or more integrated memory controller unit(s) circuitry 914 in the system agent unit circuitry 910, and special purpose logic 908, as well as a set of one or more interface controller units circuitry 916. Note that the processor 900 may be one of the processors 870 or 880, or co-processor 838 or 815 of FIG. 8.

Thus, different implementations of the processor 900 may include: 1) a CPU with the special purpose logic 908 being integrated graphics and/or scientific (throughput) logic (which may include one or more cores, not shown), and the cores 902(A)-(N) being one or more general purpose cores (e.g., general purpose in-order cores, general purpose out-of-order cores, or a combination of the two); 2) a coprocessor with the cores 902(A)-(N) being a large number of special purpose cores intended primarily for graphics and/or scientific (throughput); and 3) a coprocessor with the cores 902(A)-(N) being a large number of general purpose in-order cores. Thus, the processor 900 may be a general-purpose processor, coprocessor or special-purpose processor, such as, for example, a network or communication processor, compression engine, graphics processor, GPGPU (general purpose graphics processing unit), a high throughput many integrated core (MIC) coprocessor (including 30 or more cores), embedded processor, or the like. The processor may be implemented on one or more chips. The processor 900 may be a part of and/or may be implemented on one or more substrates using any of a number of process technologies, such as, for example, complementary metal oxide semiconductor (CMOS), bipolar CMOS (BiCMOS), P-type metal oxide semiconductor (PMOS), or N-type metal oxide semiconductor (NMOS).

A memory hierarchy includes one or more levels of cache unit(s) circuitry 904(A)-(N) within the cores 902(A)-(N), a set of one or more shared cache unit(s) circuitry 906, and external memory (not shown) coupled to the set of integrated memory controller unit(s) circuitry 914. The set of one or more shared cache unit(s) circuitry 906 may include one or more mid-level caches, such as level 2 (L2), level 3 (L3), level 4 (L4), or other levels of cache, such as a last level cache (LLC), and/or combinations thereof. While in some examples interface network circuitry 912 (e.g., a ring interconnect) interfaces the special purpose logic 908 (e.g., integrated graphics logic), the set of shared cache unit(s) circuitry 906, and the system agent unit circuitry 910, alternative examples use any number of well-known techniques for interfacing such units. In some examples, coherency is maintained between one or more of the shared cache unit(s) circuitry 906 and cores 902(A)-(N). In some examples, interface controller units circuitry 916 couple the cores 902 to one or more other devices 918 such as one or more I/O devices, storage, one or more communication devices (e.g., wireless networking, wired networking, etc.), etc.

In some examples, one or more of the cores 902(A)-(N) are capable of multi-threading. The system agent unit circuitry 910 includes those components coordinating and operating cores 902(A)-(N). The system agent unit circuitry 910 may include, for example, power control unit (PCU) circuitry and/or display unit circuitry (not shown). The PCU may be or may include logic and components needed for regulating the power state of the cores 902(A)-(N) and/or the special purpose logic 908 (e.g., integrated graphics logic). The display unit circuitry is for driving one or more externally connected displays.

The cores 902(A)-(N) may be homogenous in terms of instruction set architecture (ISA). Alternatively, the cores 902(A)-(N) may be heterogeneous in terms of ISA; that is, a subset of the cores 902(A)-(N) may be capable of executing an ISA, while other cores may be capable of executing only a subset of that ISA or another ISA.

In this description, numerous specific details are set forth to provide a more thorough understanding. However, it will be apparent to one of skill in the art that the embodiments described herein may be practiced without one or more of these specific details. In other instances, well-known features have not been described to avoid obscuring the details of the present embodiments.

The following examples pertain to further embodiments. Example 1 includes 1 includes an apparatus comprising: one or more registers to store configuration data; and a sensor having sensor event detection logic circuitry to detect an event based at least in part on one or more sensor signals and the stored configuration data, wherein the sensor event detection logic circuitry is to generate a signal to cause interrupt generator logic circuitry of the sensor to generate an interrupt.

Example 2 includes the apparatus of example 1, wherein the sensor comprises a fabric controller to transmit the generated interrupt to a fabric. Example 3 includes the apparatus of example 2, wherein the fabric is to transmit the generated interrupt to a micro-controller. Example 4 includes the apparatus of example 3, wherein the micro-controller comprises one of: a processor, a processor core, a Central Processing Unit (CPU), a power management controller, and a Field Programable Gate Array (FPGA). Example 5 includes the apparatus of example 3, wherein the micro-controller is to receive stored sensor event data from one or more data registers of the sensor in response to a request to be generated by the micro-controller and directed to the sensor in response to receipt of the generated interrupt at the micro-controller. Example 6 includes the apparatus of example 3, wherein the micro-controller is to reprogram an infield scan controller based at least on the generated interrupt. Example 7 includes the apparatus of example 6, wherein the stored configuration data is to be modified based at least in part on one or more selected functional tests to match a peak value for the sensor to generate a parametric stress functional test.

Example 8 includes the apparatus of example 1, wherein the sensor is to generate the one or more sensor signals in response to one or more detected physical characteristics of a device under test. Example 9 includes the apparatus of example 1, wherein a configuration register bank comprises the one or more registers. Example 10 includes the apparatus of example 1, wherein the one or more registers are read and/or write protected.

Example 11 includes the apparatus of example 1, wherein the sensor is to cause transmission of the generated interrupt over a fabric, wherein the fabric comprises one of: an On-Chip Fabric (OSF), an Intel® OSF (IOSF), a Peripheral Component Interconnect express (PCIe) interface, an Advanced extensible Interface (AXI), and an Advanced Peripheral Bus (APB). Example 12 includes the apparatus of example 1, wherein the apparatus is a System on Chip (SoC). Example 13 includes the apparatus of example 1, wherein the sensor comprises an analog portion to sense at least one physical characteristic of a device under test. Example 14 includes the apparatus of example 1, wherein a digital portion of the sensor comprises the one or more registers, the sensor event detection logic circuitry, and the interrupt generator logic circuitry. Example 15 includes the apparatus of example 1, wherein the stored configuration data is to cause the detection logic circuitry to detect the event based at least on one of: a single event, pattern recognition, graph pattern detection, and a time-based event.

Example 16 includes one or more non-transitory computer-readable media comprising one or more instructions that when executed on a processor configure the processor to perform one or more operations to cause: one or more registers to store configuration data; and a sensor having sensor event detection logic circuitry to detect an event based at least in part on one or more sensor signals and the stored configuration data, wherein the sensor event detection logic circuitry is to generate a signal to cause interrupt generator logic circuitry of the sensor to generate an interrupt. Example 17 includes the one or more computer-readable media of example 16, further comprising one or more instructions that when executed on the processor configure the processor to perform one or more operations to cause a fabric controller of the sensor to transmit the generated interrupt to a fabric.

Example 18 includes the one or more computer-readable media of example 16, further comprising one or more instructions that when executed on the processor configure the processor to perform one or more operations to cause a micro-controller to reprogram an infield scan controller based at least on the generated interrupt. Example 19 includes the one or more computer-readable media of example 16, further comprising one or more instructions that when executed on the processor configure the processor to perform one or more operations to cause the sensor to generate the one or more sensor signals in response to one or more detected physical characteristics of a device under test. Example 20 includes the one or more computer-readable media of example 16, further comprising one or more instructions that when executed on the processor configure the processor to perform one or more operations to cause the detection logic circuitry to detect the event based at least on one of: a single event, pattern recognition, graph pattern detection, and a time-based event based at least in part on the stored configuration data.

Example 21 includes an apparatus comprising means to perform a method as set forth in any preceding example. Example 22 includes machine-readable storage including machine-readable instructions, when executed, to implement a method or realize an apparatus as set forth in any preceding example.

In various embodiments, one or more operations discussed with reference to FIG. 1 et seq. may be performed by one or more components (interchangeably referred to herein as “logic”) discussed with reference to any of the figures.

In some embodiments, the operations discussed herein, e.g., with reference to FIG. 1 et seq., may be implemented as hardware (e.g., logic circuitry), software, firmware, or combinations thereof, which may be provided as a computer program product, e.g., including one or more tangible (e.g., non-transitory) machine-readable or computer-readable media having stored thereon instructions (or software procedures) used to program a computer to perform a process discussed herein. The machine-readable medium may include a storage device such as those discussed with respect to the figures.

Further, while various embodiments described herein use the term System-on-a-Chip or System-on-Chip (“SoC” or “SOC”) to describe a device or system having a processor and associated circuitry (e.g., Input/Output (“I/O”) circuitry, power delivery circuitry, memory circuitry, etc.) integrated monolithically into a single Integrated Circuit (“IC”) die, or chip, the present disclosure is not limited in that respect. For example, in various embodiments of the present disclosure, a device or system can have one or more processors (e.g., one or more processor cores) and associated circuitry (e.g., Input/Output (“I/O”) circuitry, power delivery circuitry, etc.) arranged in a disaggregated collection of discrete dies, tiles and/or chiplets (e.g., one or more discrete processor core die arranged adjacent to one or more other die such as memory die, I/O die, etc.). In such disaggregated devices and systems, the various dies, tiles and/or chiplets can be physically and/or electrically coupled together by a package structure including, for example, various packaging substrates, interposers, active interposers, photonic interposers, interconnect bridges, and the like. The disaggregated collection of discrete dies, tiles, and/or chiplets can also be part of a System-on-Package (“SoP”).

Additionally, such computer-readable media may be downloaded as a computer program product, wherein the program may be transferred from a remote computer (e.g., a server) to a requesting computer (e.g., a client) by way of data signals provided in a carrier wave or other propagation medium via a communication link (e.g., a bus, a modem, or a network connection).

Reference in the specification to “one embodiment” or “an embodiment” means that a particular feature, structure, and/or characteristic described in connection with the embodiment may be included in at least an implementation. The appearances of the phrase “in one embodiment” in various places in the specification may or may not be all referring to the same embodiment.

Also, in the description and claims, the terms “coupled” and “connected,” along with their derivatives, may be used. In some embodiments, “connected” may be used to indicate that two or more elements are in direct physical or electrical contact with each other. “Coupled” may mean that two or more elements are in direct physical or electrical contact. However, “coupled” may also mean that two or more elements may not be in direct contact with each other, but may still cooperate or interact with each other.

Thus, although embodiments have been described in language specific to structural features and/or methodological acts, it is to be understood that claimed subject matter may not be limited to the specific features or acts described. Rather, the specific features and acts are disclosed as sample forms of implementing the claimed subject matter.

1. An apparatus comprising:
one or more registers to store configuration data; and
a sensor having sensor event detection logic circuitry to detect an event based at least in part on one or more sensor signals and the stored configuration data,
wherein the sensor event detection logic circuitry is to generate a signal to cause interrupt generator logic circuitry of the sensor to generate an interrupt.

2. The apparatus of claim 1, wherein the sensor comprises a fabric controller to transmit the generated interrupt to a fabric.

3. The apparatus of claim 2, wherein the fabric is to transmit the generated interrupt to a micro-controller.

4. The apparatus of claim 3, wherein the micro-controller comprises one of: a processor, a processor core, a Central Processing Unit (CPU), a power management controller, and a Field Programmable Gate Array (FPGA).

5. The apparatus of claim 3, wherein the micro-controller is to receive stored sensor event data from one or more data registers of the sensor in response to a request to be generated by the micro-controller and directed to the sensor in response to receipt of the generated interrupt at the micro-controller.

6. The apparatus of claim 3, wherein the micro-controller is to reprogram an infield scan controller based at least on the generated interrupt.

7. The apparatus of claim 6, wherein the stored configuration data is to be modified based at least in part on one or more selected functional tests to match a peak value for the sensor to generate a parametric stress functional test.

8. The apparatus of claim 1, wherein the sensor is to generate the one or more sensor signals in response to one or more detected physical characteristics of a device under test.

9. The apparatus of claim 1, wherein a configuration register bank comprises the one or more registers.

10. The apparatus of claim 1, wherein the one or more registers are read and/or write protected.

11. The apparatus of claim 1, wherein the sensor is to cause transmission of the generated interrupt over a fabric, wherein the fabric comprises one of: an On-Chip Fabric (OSF), an Intel® OSF (IOSF), a Peripheral Component Interconnect express (PCIe) interface, an Advanced extensible Interface (AXI), and an Advanced Peripheral Bus (APB).

12. The apparatus of claim 1, wherein the apparatus is a System on Chip (SoC).

13. The apparatus of claim 1, wherein the sensor comprises an analog portion to sense at least one physical characteristic of a device under test.

14. The apparatus of claim 1, wherein a digital portion of the sensor comprises the one or more registers, the sensor event detection logic circuitry, and the interrupt generator logic circuitry.

15. The apparatus of claim 1, wherein the stored configuration data is to cause the detection logic circuitry to detect the event based at least on one of: a single event, pattern recognition, graph pattern detection, and a time-based event.

16. One or more non-transitory computer-readable media comprising one or more instructions that when executed on a processor configure the processor to perform one or more operations to cause:
one or more registers to store configuration data; and
a sensor having sensor event detection logic circuitry to detect an event based at least in part on one or more sensor signals and the stored configuration data,
wherein the sensor event detection logic circuitry is to generate a signal to cause interrupt generator logic circuitry of the sensor to generate an interrupt.

17. The one or more computer-readable media of claim 16, further comprising one or more instructions that when executed on the processor configure the processor to perform one or more operations to cause a fabric controller of the sensor to transmit the generated interrupt to a fabric.

18. The one or more computer-readable media of claim 16, further comprising one or more instructions that when executed on the processor configure the processor to perform one or more operations to cause a micro-controller to reprogram an infield scan controller based at least on the generated interrupt.

19. The one or more computer-readable media of claim 16, further comprising one or more instructions that when executed on the processor configure the processor to perform one or more operations to cause the sensor to generate the one or more sensor signals in response to one or more detected physical characteristics of a device under test.

20. The one or more computer-readable media of claim 16, further comprising one or more instructions that when executed on the processor configure the processor to perform one or more operations to cause the detection logic circuitry to detect the event based at least on one of: a single event, pattern recognition, graph pattern detection, and a time-based event based at least in part on the stored configuration data.
